(19) United States
(12) Patent Application Publication
(10) Pub. No.: US 2025/0116912 A1
(43) Pub. Date: Apr. 10, 2025

(54) LASER FREQUENCY CONVERSION WITH ULTRAVIOLET-DAMAGE MITIGATION

(71) Applicant: Coherent, Inc., Santa Clara, CA (US)

(72) Inventors: Alexander STEINMETZ, Santa Clara, CA (US); Andreas DIENING, Lübeck (DE); Charles Xiaoyi WANG, Fremont, CA (US)

(73) Assignee: Coherent, Inc., Santa Clara, CA (US)

(21) Appl. No.: 18/727,443

(22) PCT Filed: Dec. 19, 2022
(86) PCT No.: PCT/US2022/081934

§ 371 Date: Jul. 9, 2024

Related U.S. Application Data
(60) Provisional application No. 63/298,585, filed on Jan. 11, 2022.

(51) Int. Cl. G02F 1/35; H01S 3/00; H01S 3/109

(52) U.S. Cl. CPC G02F 1/3525; G02F 1/3532; H01S 3/0092; H01S 3/109

(57) ABSTRACT

A laser frequency conversion system with ultraviolet-damage mitigation includes a nonlinear crystal for frequency converting a laser beam, and a one-dimensional beam expander arranged to receive the laser beam from the nonlinear crystal and expand a first transverse dimension of the laser beam. This expansion protects subsequent optical elements from ultraviolet damage. To mitigate ultraviolet damage to the nonlinear crystal and the beam expander, the system also includes one or more translation stages configured to translate the nonlinear crystal and the beam expander along a translation direction that is orthogonal to the first transverse dimension of the laser beam and non-parallel to a propagation direction of the laser beam through the nonlinear crystal and the beam expander.

### CROSS-REFERENCE TO RELATED APPLICATIONS

This application is a U.S. national stage application under 35 U.S.C. § 371 of International Application No. PCT/US2022/081934, filed Dec. 19, 2022, which claims the benefit of U.S. Provisional Patent Application No. 63/298,585, filed Jan. 11, 2022. The entire contents of each priority application is incorporated herein by reference.

### FIELD OF THE DISCLOSURE

The present invention relates in general to frequency conversion of a laser beam in an optically nonlinear crystal, with at least the frequency-converted laser beam being ultraviolet and of sufficient power to cause ultraviolet damage to the nonlinear crystal. The present invention relates in particular to frequency conversion systems that utilize periodic shifting of the position of the nonlinear crystal to extend the life of the nonlinear crystal.

### BACKGROUND OF THE DISCLOSURE

Ultraviolet (UV) refers to the region of the electromagnetic spectrum between visible light and x-rays. Most broadly defined, the wavelength range of UV light is between 1 and 380 nanometers (nm). UV photons are more energetic than photons in the visible wavelength region, and UV light can therefore interact with matter in ways that visible light cannot. For example, a UV photon can ionize an atom or break a molecular bond, processes that generally require more energy than that provided by a visible-light photon.

UV laser radiation has a variety of uses, including photolithography, laser machining, eye surgery (e.g., LASIK). These applications require high precision and benefit from UV photons' capability to directly break molecular bonds and/or cause ionization. In contrast, visible and near-infrared laser radiation can only ionize atoms or break molecular bonds indirectly through the processes of multi-photon absorption or heating the target material. Heating affects not only the region directly illuminated by the laser radiation, but also the surrounding region. UV laser radiation can process materials with essentially no peripheral heating. In addition, the shorter wavelength of UV light allows for tighter focusing of a UV laser beam on the target.

Solid-state lasers present an attractive alternative to excimer lasers and ion lasers traditionally used for generating UV laser radiation. Solid-state lasers are smaller and more affordable, have very efficient lasing action, generate laser beams with good beam quality, and do not involve asphyxiating, toxic, or reactive gases. However, so far, no solid-state laser is capable of directly generating UV laser radiation with high or even moderate power. Instead, UV laser radiation is generated from solid-state lasers by frequency conversion of longer-wavelength laser radiation generated in the solid-state laser gain medium. Typically, the solid-state laser gain medium is a crystalline material, or glass, doped with rare earth ions, such as neodymium, erbium, or ytterbium. When energized in a laser resonator or amplifier, the rare earth ions can generate near-infrared laser radiation.

For example, a neodymium-doped yttrium aluminum garnet (Nd:YAG) crystal is very effective at generating laser radiation with a wavelength of 1064 nm, and forms the basis of many commonly used solid-state laser systems. The 1064 nm laser radiation may be converted to UV laser radiation through harmonic generation in one or more optically-nonlinear crystals. A wavelength of 266 nm may be reached by two sequential stages of frequency doubling, and a wavelength of 355 nm may be reached by partial frequency doubling followed by sum-frequency-mixing of the fundamental laser radiation with the frequency-doubled laser radiation.

Most nonlinear crystals are, however, susceptible to damage from a UV laser beam. This is particularly troublesome when the UV laser beam has high intensity or short wavelength, such as with ultraviolet laser beams having an average power in the kilowatt range. At high intensities and also at short wavelengths, the portion of the nonlinear crystal exposed to the UV laser beam gradually deteriorates, resulting in reduced frequency conversion efficiency and degraded UV laser beam quality. This UV-induced deterioration may be mitigated by periodically shifting the position of the nonlinear crystal, in a direction that is transverse to the propagation direction of the incident laser exposed to UV laser radiation, so as to avoid passing the laser beam through a damaged portion of the nonlinear crystal. For this purpose, the nonlinear crystal is sometimes mounted on a linear translation stage.

### SUMMARY OF THE DISCLOSURE

Disclosed herein are systems and methods for laser frequency conversion in a nonlinear crystal. The disclosed systems are suitable for frequency conversion of a visible or near-infrared laser beam to generate a UV laser beam, as well as for frequency conversion within the UV. The systems and methods are designed to mitigate UV damage not only to the nonlinear crystal but also to subsequent optical elements exposed to the UV laser beam. The present approach to UV-damage mitigation utilizes periodically shifting the nonlinear crystal to pass the laser beam through portions of the nonlinear crystal not (yet) damaged from UV exposure. In addition, the present approach entails protecting subsequent optical elements from UV damage. In a typical scenario, the first optical element, or one of the first optical elements, after the nonlinear crystal is a dichroic beamsplitter with a coating that is particularly susceptible to UV damage. Optical elements, e.g., a dichroic beamsplitter, positioned in the UV laser beam after the nonlinear crystal are protected from UV damage by a translatable one-dimensional beam expander. The beam expander is positioned after the nonlinear crystal and increases the beam spot size on a subsequent optical element to prevent UV damage to this optical element, or at least slow the rate with which such UV damage develops.

In operation, both the nonlinear crystal and the beam expander are periodically translated prior to or upon occurrence of UV damage thereof. In order to ensure that the action of the beam expander on the UV laser beam is invariant under such translation, the beam expander expands the UV laser beam only in one dimension and the beam expander is oriented such that this one dimension is orthogonal to the translation direction. In the absence of a beam-expanding element, a long path length from the nonlinear crystal to the next optical element would likely be required to prevent UV damage to subsequent optical elements. The present translatable beam expander significantly shortens the required path length to subsequent optical elements. Furthermore, by being configured to expand the UV laser beam only in the dimension orthogonal to the translation direction, translation of the beam expander does not necessitate corrections to the subsequent beam propagation. For simplicity and for ease of operation, the nonlinear crystal and the beam expander may be mounted on a common translation stage.

In one aspect, a laser frequency conversion system with ultraviolet-damage mitigation includes a nonlinear crystal for frequency converting a laser beam, and a one-dimensional beam expander arranged to receive the laser beam from the nonlinear crystal and expand a first transverse dimension of the laser beam. This laser frequency conversion system also includes one or more translation stages configured to translate the nonlinear crystal and the beam expander along a translation direction that is orthogonal to the first transverse dimension of the laser beam and non-parallel to a propagation direction of the laser beam through the nonlinear crystal and the beam expander.

In another aspect, a laser frequency conversion method with ultraviolet-damage mitigation includes the steps of frequency converting a laser beam in a nonlinear crystal, expanding a first transverse dimension of the laser beam, as frequency converted, with a beam expander, and translating the nonlinear crystal and the beam expander along a translation direction that is orthogonal to the first transverse dimension and non-parallel to a propagation direction of the laser beam through the nonlinear crystal and the beam expander.

### BRIEF DESCRIPTION OF THE DRAWINGS

The accompanying drawings, which are incorporated in and constitute a part of the specification, schematically illustrate preferred embodiments of the present invention, and together with the general description given above and the detailed description of the preferred embodiments given below, serve to explain principles of the present invention.

FIGS. 1A and 1B illustrate a laser frequency conversion system with UV-damage mitigation based on translation of both a nonlinear crystal and a one-dimensional beam expander, according to an embodiment.

FIGS. 2A-C illustrate a laser frequency conversion system with one-dimensional beam expansion by a cylindrical lens, according to an embodiment.

FIG. 3 illustrates another laser frequency conversion system with initial one-dimensional beam expansion by a cylindrical lens, followed by one-dimensional beam expansion in the orthogonal transverse dimension by a curved dichroic beamsplitter, according to an embodiment.

FIGS. 4A and 4B illustrate a laser frequency conversion system with one-dimensional beam expansion by an anamorphic prism pair, according to an embodiment.

### DETAILED DESCRIPTION OF THE DISCLOSURE

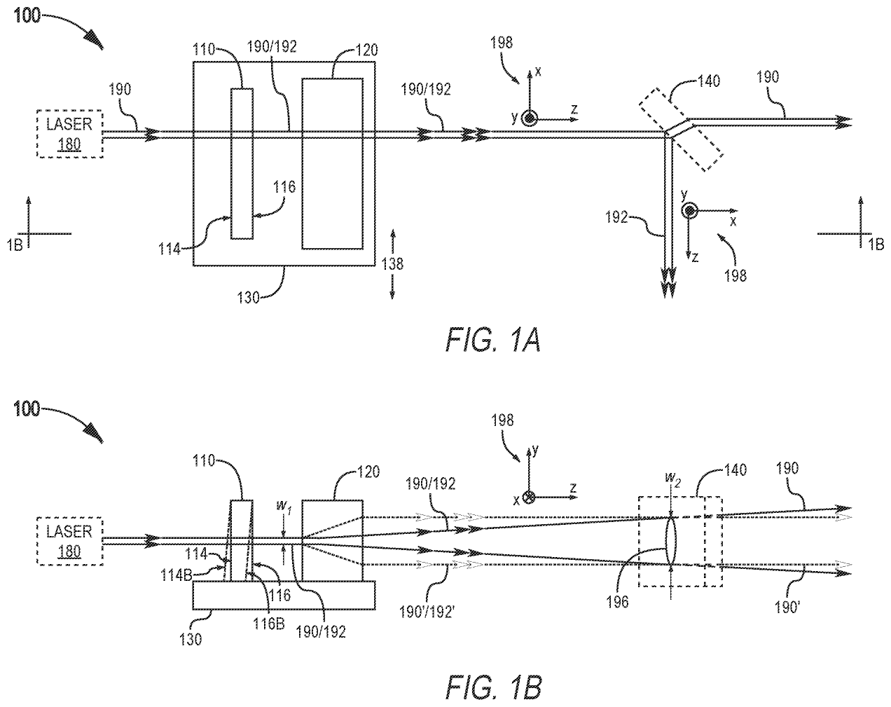

Referring now to the drawings, wherein like components are designated by like numerals, FIGS. 1A and 1B illustrate one laser frequency conversion system 100 with UV-damage mitigation. System 100 is configured to convert the frequency of an incident laser beam 190 in a nonlinear crystal 110 to generate a UV laser beam 192. Incident beam 190 may be visible, near-infrared, or ultraviolet. Incident beam 190 may be fully or partly converted into UV beam 192. In certain scenarios, UV beam 192 has a wavelength in the range between 190 and 380 nm.

FIGS. 1A and 1B show system 100 from two orthogonal viewing directions. Arrows 1B, depicted in FIG. 1A, indicate the viewing direction used in FIG. 1B. Each of FIGS. 1A and 1B further shows a cartesian coordinate system 198 referenced to UV beam 192, with UV beam 192 propagating in the positive z-direction. The propagation of each of beams 190 and 192 is depicted by a pair of arrows, with each arrow schematically indicating the transverse dimension of beam 190/192. Incident beam 190 is indicated with a single arrowhead, while UV beam 192 is indicated with double arrowheads.

In one scenario, nonlinear crystal 110 generates a harmonic of incident beam 190, e.g., a second harmonic of incident beam 190. For example, nonlinear crystal 110 may frequency-double an incident laser beam with a wavelength of 532 nanometers (nm) to generate a 266 nm UV beam. In another scenario, nonlinear crystal 110 receives a second laser beam together with incident beam 190 and generates UV beam 192 from sum-frequency mixing of incident beam 190 with this second laser beam, or incident beam 190 has two frequency components that are sum-frequency mixed in nonlinear crystal 110. In one such example, incident beam 190 is generated from a 1064 nm laser beam and includes a 532 nm component generated by partial frequency-doubling of the 1064 nm laser beam. In this example, nonlinear crystal 110 generates UV beam 192 with a wavelength of 355 nm from sum-frequency mixing of the 532 nm radiation with the remaining 1064 nm radiation. Nonlinear crystal is, for example, made of beta barium borate (BBO), lithium triborate (LBO), cesium lithium triborate (CLBO), or lithium tetraborate (LTB).

System 100 includes nonlinear crystal 110, a one-dimensional beam expander 120, and a translation stage 130. Nonlinear crystal 110 frequency-converts at least a portion of incident beam 190 to generate UV beam 192. System 100 may include a laser 180 that generates incident beam 190, or be implemented in a laser apparatus that includes laser 180. Nonlinear crystal 110 is mounted on translation stage 130. Translation stage 130 is configured to translate nonlinear crystal 110 in a direction 138 that is non-parallel to the propagation direction of beams 190 and 192 through nonlinear crystal 110. Translation direction 138 is in the xy-plane and may be parallel to the x-axis. Translation of nonlinear crystal 110 may be performed in anticipation of the occurrence of non-negligible local UV damage in the region of nonlinear crystal 110 exposed to UV beam 192, or when it is determined that such damage has developed. Translation stage 130 enables shifting the path of beams 190 and 192 through nonlinear crystal 110 to a different region of nonlinear crystal 110 with no UV damage or a tolerable level of UV damage. In scenarios where incident beam 190 is ultraviolet as well, the translation of nonlinear crystal 110 by translation stage 130 also mitigates UV damage in nonlinear crystal 110 caused by incident beam 190.

Translation stage 130 may be a linear translation stage, optionally motorized to allow its translation to be controlled externally and even automatically. Although not shown in FIGS. 1A and 1B, system 100 may include a controller that controls the actuation of translation stage 130.

In one scenario, incident beam 190 is nearly collimated, possibly with a slight waist in nonlinear crystal 110. For example, when incident beam 190 is a pulsed laser beam, its peak power may be sufficiently high for efficient frequency conversion in nonlinear crystal 110 without significant focusing of incident beam 190 therein. In this scenario, UV beam 192 is typically only slowly diverging when emerging from nonlinear crystal 110. Until the size of UV beam 192 has grown significantly, optical elements placed in the path of UV beam 192 are at risk of UV degradation. Due to the slow rate of divergence of UV beam 192, the propagation distance to a “safe” location for subsequent optical elements may be undesirably long. Beam expander 120 shortens the propagation distance to a safe location by proactively expanding UV beam 192.

In scenarios where a laser beam, to be frequency converted in a nonlinear crystal, is continuous-wave or pulsed with relatively low peak power, the laser beam may be focused in the nonlinear crystal in order to achieve a reasonable conversion efficiency. The resulting UV beam is thus diverging relatively fast, and the propagation distance to a safe location for subsequent optical elements is shorter than when UV beam 192 is only slowly diverging. Even in such scenarios, it may be advantageous to use system 100 with beam expander 120 so as to further shorten the propagation distance to a safe location for subsequent optical elements.

Beam expander 120 receives UV beam 192 from nonlinear crystal 110 and expands the y-dimension of UV beam 192. This expansion is visible in FIG. 1B. The y-dimension of UV beam 192 (and any remaining non-frequency-converted portion of incident beam 190) increases after and/or within beam expander 120 from an initial y-dimension w₁, when incident on beam expander 120, to a larger y-dimension w₂ at the output of beam expander 120 or a distance therefrom. This one-dimensional expansion reduces the intensity of UV beam 192 to protect a subsequent optical element 140 from UV damage. The one-dimensional expansion results in an elongated, typically elliptical, illumination spot 196 of UV beam 192 on optical element 140. In one scenario, the intensity of UV beam 192, when its y-dimension is w₂, is below the UV damage threshold for optical element 140, such that it is unnecessary to translate or replace optical element 140. Depending on the power of UV beam 192 and the UV damage threshold of optical element 140, the value of w₂ may be at least two, five, or ten times the value of w₁.

In one embodiment, the propagation path of UV beam 192, and any remaining portion of incident beam 190, between beam expander 120 and optical element 140 is free of optical elements. Alternatively, the propagation path of UV beam 192 between beam expander 120 and optical element 140 may pass through one or more optical elements characterized by a high UV damage threshold.

In order to mitigate UV damage to beam expander 120 itself, beam expander 120 is also mounted on translation stage 130 and translated together with nonlinear crystal 110. To ensure that translation of beam expander 120 does not affect the properties of UV beam 192, the action of beam expander 120 on UV beam 192 is invariant under translation of beam expander 120 along translation direction 138, within a certain range of positions along translation direction 138. This translation invariance would not be possible with, for example, two-dimensional beam expansion by a spherical lens. The one-dimensional nature of the beam expansion by beam expander 120 ensures the translation invariance.

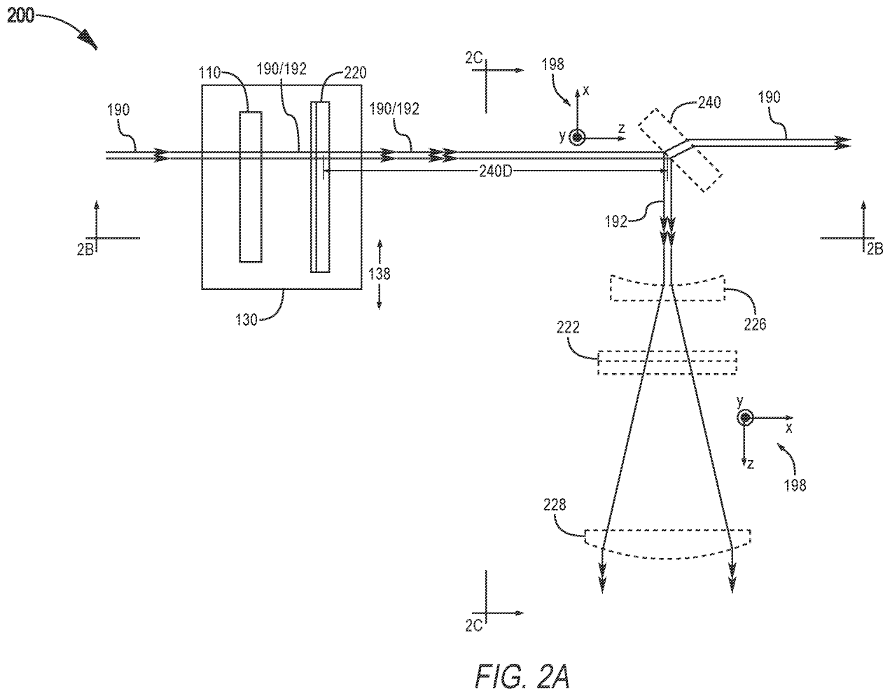

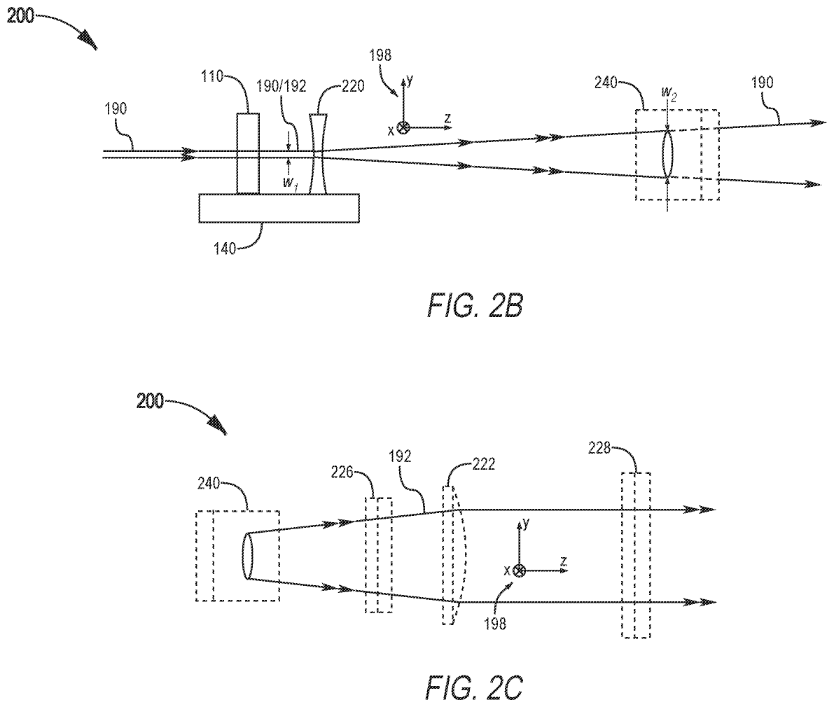

In certain embodiments, such as those discussed below in reference to FIGS. 2A-4B, beam expander 120 is based on one or more solid optics refracting UV beam 192. Each such solid optic, or at least the portion thereof exposed to UV beam 192, may have a cross-sectional shape in the plane orthogonal to translation direction 138 (the yz-plane when translation direction 138 is along the x-dimension) that is constant throughout the extent of the solid optic along the translation direction 138.

Some degree of diffraction-mediated expansion of UV beam 192 in the orthogonal dimension, the x-dimension, may be incorporated in beam expander 120, for example by holographic diffraction features. However, such diffraction-mediated expansion is undesirable in most use scenarios because of the effect of diffraction on the mode of UV beam 192.

In one embodiment, beam expander 120 defocuses UV beam 192, such that UV beam 192 is diverging after beam expander 120, as indicated by solid arrows with filled arrowheads in FIG. 1B. In this embodiment, beam expander 120 may consist of, or include, a cylindrical lens with negative optical power in the y-dimension. In another embodiment, not depicted in FIGS. 1A and 1B, beam expander focuses UV beam 192, such that UV beam 192 comes to a focus after beam expander 120 and diverges after this focus. In this embodiment, beam expander 120 may consist or, or include, a cylindrical lens with positive optical power in the y-dimension. When beam expander 120 is based on a cylindrical lens, whether its optical power is positive or negative, the cylindrical lens is oriented with its cylinder axis parallel to translation direction 138. With this orientation of the cylinder axis, the action of the cylindrical lens on UV beam 192 is invariant under translation along translation direction 138.

In yet another embodiment, beam expander 120 increases the y-dimension of UV beam 192 without substantially changing the divergence of UV beam 192, as indicated by the dashed arrows with open arrowheads and labeled 190′/192′. In this embodiment, beam expander 120 may consist of, or include, one or more prisms oriented to refract UV beam 192 in the yz-plane, for example an anamorphic prism pair.

Nonlinear crystal 110 has an entry face 114 that receives incident beam 190, and an exit face 116 through which UV beam 192 exits nonlinear crystal 110. In the embodiment of nonlinear crystal 110 depicted with solid lines in FIGS. 1A and 1B, faces 114 and 116 are in the xy-plane. Preferably, translation direction 138 is parallel to faces 114 and 116, such that the propagation path and beam parameters of beams 190 and 192 are unaffected by translation of nonlinear crystal 110 along translation direction 138. In certain embodiments, the entry and exit faces of nonlinear crystal 110 are at an oblique angle to the propagation direction of incident beam 190, for example at Brewster's angle to incident beam 190 in order to reduce or prevent reflection losses. One such embodiment is depicted in FIG. 1B with dashed lines indicating an entry face 114B and an exit face 116B oriented at an oblique angle to the xy-plane. Faces 114B and 116B are parallel to translation direction 138, such that the propagation path and beam parameters of beams 190 and 192 are unaffected by translation of nonlinear crystal 110.

System 100 may include optical element 140 or be implemented in an apparatus configured with optical element 140. In the embodiment depicted in FIGS. 1A and 1B, optical element 140 is a dichroic beamsplitter that separates UV beam 192 from a remaining non-frequency-converted portion of incident beam 190. The dichroic beamsplitter may reflect UV beam 192 and transmit the remaining portion of incident beam 190, as shown in FIG. 1A, or vice versa. In order to separate beams 190 and 192 from each other, the dichroic beamsplitter includes a dielectric coating. This dielectric coating is particularly susceptible to UV damage and thus benefits significantly from the beam expansion imparted by beam expander 120.

FIGS. 2A-C illustrate one laser frequency conversion system 200 with one-dimensional beam expansion by a cylindrical lens. System 200 is an embodiment of system 100 that implements beam expander 120 as a negative cylindrical lens 220. FIGS. 2A and 2B show system 200 in views similar to those used for system 100 in FIGS. 1A and 1B, respectively. FIG. 2A depicts arrows 2B and 2C that indicate the viewing directions used in FIGS. 2B and 2C, respectively. Each of FIGS. 2A-C further shows coordinate system 198.

In system 200, cylindrical lens 220 has negative optical power and its cylinder axis is parallel to the x-dimension of UV beam 192. Cylindrical lens 220 therefore defocuses the y-dimension of UV beam 192 (as well as of any remaining non-frequency-converted portion of incident beam 190). This is evident in FIGS. 2A and 2B. When emerging from cylindrical lens 220, UV beam 192 is diverging in the y-dimension as shown in FIG. 2B, while the x-dimension of UV beam 192 is unaffected by cylindrical lens 220, as shown in FIG. 2A.

The cylinder axis of cylindrical lens 220 is parallel to translation direction 138, such that the beam parameters of UV beam 192 are invariant under translation of cylindrical lens 220 along translation direction 138. In one embodiment, translation direction 138 and the cylinder axis of cylindrical lens 220 are substantially parallel to the x-dimension of UV beam 192 when passing through cylindrical lens 220. Although not depicted in FIGS. 2A-C, a non-negligible walk-off angle may exist between beams 190 and 192 in nonlinear crystal 110.

Certain embodiments of system 200 include a dichroic beamsplitter 240 similar to the dichroic beamsplitter embodiment of optional optical element 140 of system 100. Beamsplitter 240 reflects UV beam 192. In the implementation depicted in FIGS. 2A-C, beamsplitter 240 is oriented to deflect UV beam 192 within the plane containing translation direction 138 and the propagation direction of UV beam 192 through cylindrical lens 220 (corresponding to maintaining the same orientation of the y-dimension of UV beam 192).

The y-dimension w₂ of UV beam 192 on beamsplitter 240 is determined principally by (a) the focal length of cylindrical lens 220 and (b) the propagation distance 240D of UV beam 192 from the principal plane of cylindrical lens 220 to beamsplitter 240. In one implementation, propagation distance 240D exceeds the absolute value of the focal length of cylindrical lens 220. For example, propagation distance 240D may be at least two (or at least five or ten) times the absolute value of the focal length of cylindrical lens 220, so as to expand the y-dimension of UV beam 192 by approximately a factor of at least two (or at least five or ten) from cylindrical lens 220 to beamsplitter 240.

In an alternative embodiment, not depicted in FIGS. 2A-C, cylindrical lens 220 has positive optical power and brings the y-dimension of UV beam 192 to a focus whereafter UV beam 192 diverges.

As shown in FIGS. 2A and 2C, system 200 may also include one or more additional cylindrical lenses positioned in the propagation path of UV beam 192 after beamsplitter 240. These cylindrical lenses may be arranged to shape UV beam 192 as desired. For example, system 200 may include a positive cylindrical lens 222 that collimates the y-dimension of UV beam 192. System 200 may also include a pair of cylindrical lenses 226 and 228 that expand and collimate, respectively, the x-dimension of UV beam 192. The optical power of cylindrical lens 228 is positive. As depicted in FIG. 2A, the optical power of cylindrical lens 226 may be negative such that the x-dimension of UV beam 192 is diverging between cylindrical lenses 226 and 228. Alternatively, cylindrical lens 226 may have positive optical power and form a focus in the x-dimension of UV beam 192 between cylindrical lenses 226 and 228. In one embodiment of system 200 that implements all of cylindrical lenses 220, 222, 226, and 228, these cylindrical lenses are configured to expand the x- and y-dimensions of UV beam 192 by equal amounts, so as to produce a circular beam profile.

Without departing from the scope hereof, beamsplitter 240 may be oriented to reflect UV beam 192 out of the plane containing translation direction 138 and the propagation direction of UV beam 192 through cylindrical lens 220. For example, beamsplitter 240 may be rotated by ninety degrees, compared to the embodiment depicted in FIGS. 2A-C, such the propagation direction of UV beam 192 after beamsplitter 240 is orthogonal to the plane containing translation direction 138 and the propagation direction of UV beam 192 through cylindrical lens 220. However, the configuration depicted in FIGS. 2A-C may be more practical since translation direction 138 and beam propagation are coplanar. Also, without departing from the scope hereof, one or more of cylindrical lenses 222, 226, and 228 may be positioned before beamsplitter 240, with the first one of these cylindrical lenses being at distance 240D from cylindrical lens 220 to prevent UV damage.

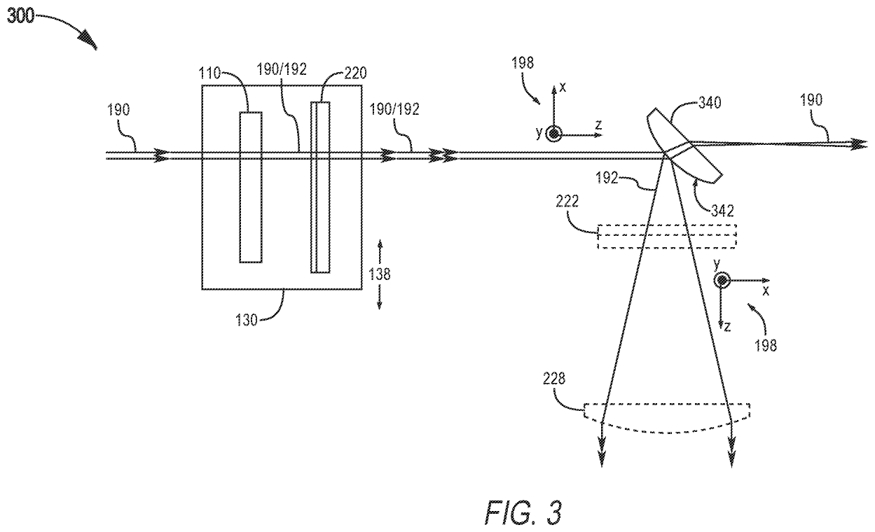

FIG. 3 illustrates another laser frequency conversion system 300 with initial one-dimensional beam expansion by a cylindrical lens, followed by one-dimensional beam expansion in the orthogonal transverse dimension by a curved dichroic beamsplitter. System 300 is an embodiment of system 200 that implements a dichroic beamsplitter 340 with a cylindrical reflective surface 342. The cylinder axis of surface 342 is parallel to the y-dimension of UV beam 192. Beamsplitter 340 therefore expands the x-dimension of UV beam 192. Beamsplitter 340 may have negative optical power, as shown in FIG. 3, such that the x-dimension of UV beam 192 is diverging after reflection off surface 342. Alternatively, beamsplitter 340 has positive optical power, such that the x-dimension of UV beam 192 comes to an initial focus before diverging. Beamsplitter 340 combines, into one optical element, the functionality of beamsplitter 240 and cylindrical lens 226 of system 200. System 300 may further include cylindrical lenses 222 and 228.

In a different embodiment, not depicted in FIG. 3, reflective surface 342 of beamsplitter 340 is instead configured to collimate the y-dimension of UV beam 192. In this embodiment, beamsplitter 340 may be oriented to reflect UV beam 192 out of the plane containing translation direction 138 and the propagation direction of UV beam 192 through cylindrical lens 220.

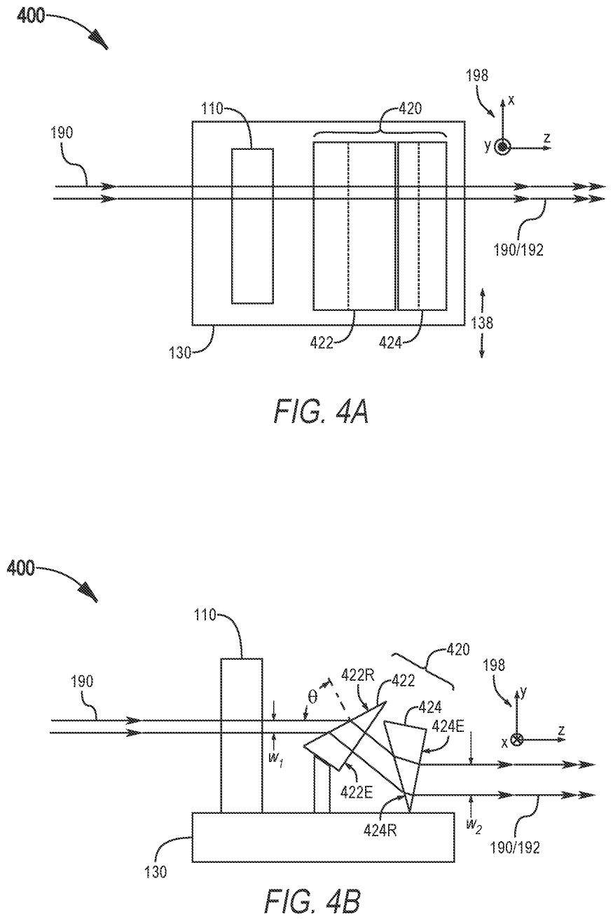

FIGS. 4A and 4B illustrate one laser frequency conversion system 400 with one-dimensional beam expansion by an anamorphic prism pair 420. System 400 is an embodiment of system 100, and anamorphic prism pair 420 is an embodiment of beam expander 120. FIGS. 4A and 4B are orthogonal views of system 400 and the propagation path of beams 190 and 192 through nonlinear crystal 110 and anamorphic prism pair 420.

Anamorphic prism pair 420 includes two prisms 422 and 424. Each of prisms 422 and 424 refracts UV beam 192 and expands its y-dimension. The amount of expansion provided by each of prisms 422 and 424 is determined by its apex angle. Prisms 422 and 424 are oriented such that the propagation direction of UV beam 192 after anamorphic prism pair 420 is parallel to the propagation direction of UV beam 192 before anamorphic prism pair 420. This is often the most practical approach to managing laser beam propagation, especially in implementations where translation direction 138 is parallel to a supporting platform. Prisms 422 and 424 cooperate to expand the y-dimension of UV beam 192 from an initial y-dimension w₁ to a greater y-dimension w₂. The relationship between the values of w₁ and w₂ may be similar to that discussed above in reference to FIGS. 1A-2C.

In contrast to cylindrical lens 220, anamorphic prism pair 420 does not affect the divergence of UV beam 192. Thus, if UV beam 192 is collimated when entering the first prism 422 of anamorphic prism pair 420, UV beam 192 will remain collimated through anamorphic prism pair 420 and be collimated also when exiting the second prism 424, as shown in FIGS. 4A and 4B.

To reduce reflective losses, one or more of the surfaces of prisms 422 and 424 that intersect UV beam 192 may have an anti-reflective coating. Such coatings are, however, particular susceptible to UV damage. The light-receiving surface 422R of prism 422 (see FIG. 4B) is subject to the highest UV intensity, since UV beam 192 has not yet been expanded by anamorphic prism pair 420 when incident on surface 422R. In one embodiment, configured to minimize the rate of UV degradation of anamorphic prism pair 420, surface 422R does not have an anti-reflective coating. Instead, prism 422 is oriented such that the incidence angle θ of UV beam 192 on surface 422R is at or near Brewster's angle. Each of the exit surface 422E of prism 422, the receiving surface 424R, and the exit surface 424E are subject to lower UV intensities and may have an anti-reflective coating. If the intensity of UV beam 192 at the middle surfaces 422E and 424R of anamorphic prism pair 420 is deemed unsuitable for an anti-reflective coating, it may be preferable to omit an anti-reflective coating from these surfaces and instead accept reflective losses. The ability to orient surface 422R at Brewster's angle is one advantage of anamorphic prism pair 420 over cylindrical lens 220. While the surfaces of cylindrical lens 220 may have anti-reflective coatings, such coatings will likely exhibit a relatively high rate of UV degradation, necessitating more frequent translation of cylindrical lens 220.

In scenarios where the initial beam expansion by prism 422 is sufficient to substantially reduce or even eliminate UV damage to prism 424, prism 424 may be mounted away from translation stage 130 and remain stationary while translation stage 130 translates nonlinear crystal 110 and prism 422. In a further modification, suitable when it is not desired or not particularly advantageous to maintain parallel propagation directions of UV beam 192 before and after beam expansion, prism 424 may be omitted entirely. In this case, the apex angle of prism 422 may be set to provide a sufficient amount of beam expansion to protect subsequent optical elements from UV damage.

Although not shown in FIGS. 4A and 4B, system 400 may include laser 180, optical element 140, and/or one or more lenses for further beam forming. For example, system 400 may include (a) beamsplitter 240 and, optionally, cylindrical lenses 226 and 228 for expansion of the x-dimension of UV beam 192 as discussed above in reference to FIGS. 2A-C, or (b) beamsplitter 340 and, optionally, cylindrical lens 228 for expansion of the x-dimension of UV beam 192 as discussed above in reference to FIG. 3.

Without departing from the scope hereof, the embodiments discussed above in reference to FIGS. 1A-4B may be modified to implement separate translation stages for nonlinear crystal 110 and beam expander 120 (e.g., cylindrical lens 220 or anamorphic prism pair 420). While this is more complex than using a single, common translation stage for nonlinear crystal 110 and beam expander 120, such implementations allow for independent translation of nonlinear crystal 110 and beam expander 120. Independent translation may be desirable if the UV damage to nonlinear crystal 110 and beam expander 120 have different properties, for example if the spatial extent of the UV damage or its rate of development is not the same in beam expander 120 as in nonlinear crystal 110.

The present invention is described above in terms of a preferred embodiment and other embodiments. The invention is not limited, however, to the embodiments described and depicted herein. Rather, the invention is limited only by the claims appended hereto.

What is claimed is:

1. A laser frequency conversion system with ultraviolet-damage mitigation, comprising:
a nonlinear crystal for frequency converting a laser beam;
a one-dimensional beam expander arranged to receive the laser beam from the nonlinear crystal and expand a first transverse dimension of the laser beam; and
one or more translation stages configured to translate the nonlinear crystal and the beam expander along a translation direction that is orthogonal to the first transverse dimension of the laser beam and non-parallel to a propagation direction of the laser beam through the nonlinear crystal and the beam expander.

2. The system of claim 1, wherein the translation direction is orthogonal to the propagation direction.

3. The system of claim 1, wherein the beam expander is configured to expand only the first transverse dimension of the laser beam while leaving an orthogonal second transverse dimension of the laser beam unaffected, and wherein expansion of the laser beam by the beam expander is invariant under translation of the beam expander along the translation direction.

4. The system of claim 1, further comprising a dichroic optical element for separating a frequency-converted component of the laser beam, generated in the nonlinear crystal, from a remaining non-frequency-converted component of the laser beam, the dichroic optical element being arranged to intercept the laser beam after the beam expander.

5. The system of claim 4, wherein the distance from the beam expander to the dichroic optical element, along the propagation direction of the laser beam, is such that the first transverse dimension of the laser beam at the dichroic optical element is at least doubled compared to the first transverse dimension of the laser beam when incident on the beam expander.

6. The system of claim 1, wherein the beam expander is a first cylindrical lens arranged with its cylinder axis parallel to the translation direction.

7. The system of claim 6, wherein the first cylindrical lens has negative optical power.

8. The system of claim 7, further comprising a dichroic optical element for separating a frequency-converted component of the laser beam from a remaining non-frequency-converted component of the laser beam, the dichroic optical element being arranged to intercept the laser beam after the first cylindrical lens, wherein the distance between the first cylindrical lens and the dichroic optical element, along the propagation direction of the laser beam, exceeds the focal length of the first cylindrical lens.

9. The system of claim 6, further comprising a second cylindrical lens configured to intercept the laser beam after the first cylindrical lens and collimate the first transverse dimension of the laser beam, the second cylindrical lens having positive optical power.

10. The system of claim 6, further comprising a dichroic optical element for separating a frequency-converted component of the laser beam from a remaining non-frequency-converted component of the laser beam, the dichroic optical element being arranged to intercept the laser beam after the first cylindrical lens.

11. The system of claim 10, further comprising:
a second cylindrical lens configured to intercept the frequency-converted component of the laser beam after the dichroic optical element and collimate the first transverse dimension of the frequency-converted component of the laser beam, the second cylindrical lens having positive optical power;
a third cylindrical lens arranged to intercept the frequency-converted component of the laser beam after the dichroic optical element and expand a second transverse dimension of the frequency-converted component of the laser beam orthogonal to the first transverse dimension; and
a fourth cylindrical lens arranged to intercept the frequency-converted component of the laser beam after the third cylindrical lens and collimate the second transverse dimension of the frequency-converted component of the laser beam, the fourth cylindrical lens having positive optical power.

12. The system of claim 10, wherein the dichroic optical element is a cylindrical dichroic mirror.

13. The system of claim 1, wherein the beam expander is an anamorphic prism pair.

14. The system of claim 13, wherein a first face of the anamorphic prism pair, configured to receive the laser beam from the nonlinear crystal, is oriented at Brewster's angle to the laser beam.

15. The system of claim 13, further comprising a dichroic optical element for separating a frequency-converted component of the laser beam from a remaining non-frequency-converted component of the laser beam, the dichroic optical element being arranged to intercept the laser beam after the anamorphic prism pair.

16. The system of claim 1, wherein the beam expander is a first prism configured to deflect the laser beam in the plane orthogonal to the translation direction.

17. The system of claim 16, further comprising:
a second prism arranged to intercept the laser beam after the first prism, the second prism being arranged separately from the one or more translation stages, the first and second prisms forming an anamorphic prism pair.

18. A laser frequency conversion method with ultraviolet-damage mitigation, comprising the steps of:
frequency converting a laser beam in a nonlinear crystal;
expanding a first transverse dimension of the laser beam, as frequency converted, with a beam expander; and
translating the nonlinear crystal and the beam expander along a translation direction that is orthogonal to the first transverse dimension and non-parallel to a propagation direction of the laser beam through the nonlinear crystal and the beam expander.

19. The method of claim 18, wherein expansion of the first transverse dimension in the expanding step is insensitive to translation imparted in the translating step.

20. The method of claim 18, further comprising a step of separating, with a dichroic optical element, a frequency-converted component of laser beam from a remaining non-frequency-converted component of the laser beam, wherein the dichroic optical element is arranged to intercept the laser beam after the beam expander.
